(19) United States
(12) Patent Application Publication
(10) Pub. No.: US 2009/0200117 A1
(43) Pub. Date: Aug. 13, 2009

(54) SLIDER SCISSOR LIFT FOR A VEHICLE OPERATOR CONSOLE

(76) Inventors: Bruce W. Farber, Oxnard, CA (US); Aaron Alls, Ventura, CA (US); Joseph Beck, Oxnard, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/029,997

(22) Filed: Feb. 12, 2008

(51) Int. Cl. B66B 9/02

(52) U.S. Cl. 187/269

(57) ABSTRACT

An improved slider scissor lift results in forward or backward movement of a raised work platform. The forward or backward movement is achieved by positioning upper pins and sliders oppositely from lower pins and sliders. This oppositely pinned configuration results in an operation whereby the base of the scissor lift is moved toward the rear of the base platform and the work platform is drawn toward the rear of the scissor lift.

### FIELD OF THE INVENTION

This invention relates to a lift mechanism for a vehicle operator console. More specifically, the present invention relates to an improved slider scissor lift for raising and lowering an operator console on forklifts and similar vehicles.

### BACKGROUND OF THE INVENTION

Forklifts are used in a wide variety of areas to lift and transport large, heavy and/or awkward loads. Such cannot be more true in the boat storage market. Boat storage facilities continue to experience an increased demand in storage space due to an increase in boat ownership. Additionally, the shortage and high price of waterfront land increases the need for offshore boat storage facilities. These boat storage facilities are the equivalent of large warehouses. In order to optimize storage and warehouse space, boat storage facility owners fill their buildings with racks stretching both horizontally and vertically throughout the storage facility. Such a multi-rack configuration is cost-effective as more boats are able to be stored in a smaller footprint.

Stacked multi-rack configurations require that not only load bearing forks be raised to reach the upper racks, but that the operator console also be raised so the operator can more clearly see the position of the boat as it is inserted into the rack. With the size of some boats and protrusions from the hulls, i.e., rudders or keel fins, it is necessary that the operator have a good vantage point to observe the boat.

A common method for raising an operator console is a scissor lift. A scissor lift uses a multiplicity of bars, pins and sliders to raise and lower a working platform. A plurality of bars are pinned together to form X-shaped structures. In such prior art devices, one end of the scissor lift is pinned to the base platform, where the other end of the scissor lift slides within a constrained channel on the other end of the base platform. Similarly, the scissor lift is pinned to the work platform at the same end as the base platform, and the other end of the scissor lift is allowed to slide in a constrained channel on the other end of the work platform. In this prior art configuration, the scissor lift is fixedly connected to both the base platform and the work platform at the same end, i.e., the rear of the vehicle, and the sliders are similarly positioned at the same end, i.e., the front of the vehicle. In such configuration the work platform is raised directly over its closed, resting position.

In marina forklifts and similar devices, this configuration poses a problem. Where both the forklift and the operator console are in raised positions, the forklift may come into contact with the operator console. This is especially true where the forklift may need to be tilted or angled back several degrees. Such contact between the forklift and the operator console can result in damage to the forklift, damage to the boat, or injury to the operator. The avoidance of such contact cannot be achieved merely by moving the operator console farther back on the marina forklift. With the premium placed upon storage space, marina forklifts cannot be made larger than a specified size without the need to increase maneuvering space between storage racks.

Accordingly, there exists a significant need for an improved slider scissor lift to raise an operator console on a marina forklift. This improved slider scissor lift must raise an operator console in such a way that it does not create a risk of contact with a raised forklift. Further, this contact must be avoided by a means other than moving the operator console further back on the marina forklift. The present invention fulfills these needs and provides other related advantages.

### SUMMARY OF THE INVENTION

An improved slider scissor lift for a vehicle operator console comprises a work platform carrying the operator console and a base platform associated with the vehicle. A scissor lift is disposed between the work platform and the base platform. The scissor lift includes a lower fixed pin connected to the base platform adjacent to a first end of the vehicle, and an upper fixed pin connected to the work platform adjacent to an opposite second end of the vehicle. Further, the scissor lift includes upper and lower sliders positioned oppositely from the upper and lower fixed pins. The lower slider moves along a lower constrained channel on the base platform adjacent the second end of the vehicle. Similarly, the upper slider moves along an upper constraint channel on the work platform adjacent the first end of the vehicle.

In a preferred embodiment, the first end of the vehicle is the rear end of the vehicle and the second end of the vehicle is the front end of the vehicle. In this configuration, where the lower fixed pin of the scissor lift is connected near the rear of the vehicle and the upper fixed pin is connected near the front of the vehicle, the work platform will be moved backwards toward the rear of the vehicle as the scissor lift is raised. Alternatively, the first end of the vehicle may be the front end and the second end of the vehicle may be the rear end. In such configuration where the lower fixed pin of the scissor lift is near the front of the vehicle and the upper fixed pin of the scissor lift is near the rear of the vehicle, the work platform moves forward as the scissor lift is raised.

A pair of scissor lifts may be disposed between the base platform and the work platform. In this case, each scissor lift will include lower fixed pins connected to the base platform adjacent to the first end of the vehicle. Each scissor lift also includes upper fixed pins connected to the work platform adjacent to the opposite second end of the vehicle. Each pair of scissor lifts include upper and lower sliders positioned oppositely from the upper and lower fixed pins respectively. The lower sliders each move along lower constrained channels on the base platform adjacent the second end of the vehicle. Also, the upper sliders each move along upper constrained channels on the work platform adjacent the first end of the vehicle. A hydraulic cylinder is included for opening and closing the scissor lifts.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a depiction of a prior art scissor lift in a lowered position;

FIG. 2 is a depiction of a prior art scissor lift in a raised position;

FIG. 3 is a perspective view of a boat lifting and stacking vehicle incorporating the slider scissor lift of the present invention;

FIG. 4 illustrates a scissor lift embodying the present invention in a lowered position;

FIG. 5 illustrates a scissor lift embodying the present invention in a partially raised position; and

FIG. 6 illustrates a scissor lift embodying the present invention in a raised position.

### DETAILED DESCRIPTION OF THE PREFERRED EMBODIMENTS

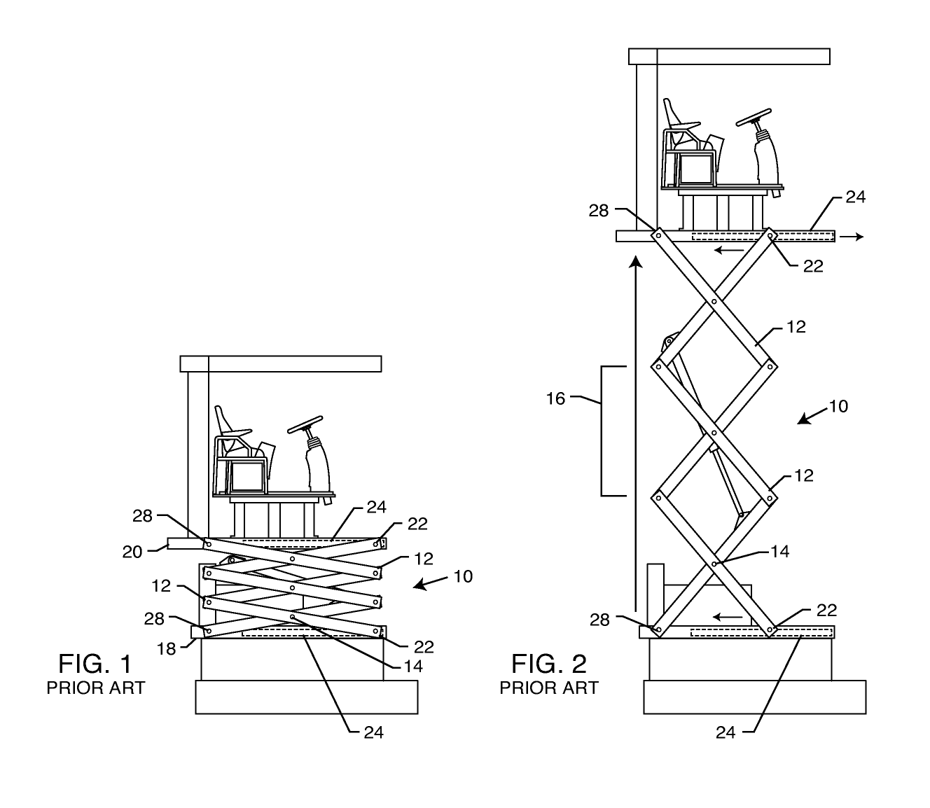

As shown in the drawings for purposes of illustration, the present invention is concerned with a slider scissor lift. FIGS. 1 and 2 depict a prior art version of a slider scissor lift 10. The prior art scissor lift 10 consists of a plurality of bars 12 joined together by pins 14 at their midpoint. Such joining creates an X-shaped structure 16. Multiples of these X-shaped structures 16 are then pinned together at their respective ends to form the scissor lift 10. The more X-shaped structures 16 included in the scissor lift 10, the greater the extension to be achieved by the scissor lift 10. However, the greater the extension of the scissor lift 10, the lower the stability thereof.

In the prior art, the slider scissor lift 10 is affixed at either the front end or the rear end to both a base platform 18 and a work platform 20. At the opposite side of the scissor lift 10, sliders 22 are positioned in constrained channels 24 on both the base platform 18 and the work platform 20.

In the prior art embodiment depicted in FIGS. 1 and 2, the back of the scissor lift 10 is pinned at points 28 on both the base platform 18 and work platform 20. These pin points 28 fix the scissor lift 10 so it cannot move from this point. The opposite side of the scissor lift 10 has the sliders 22 which are engaged in the constrained channels 24. As the scissor lift 10 is opened, the back of the scissor lift remains fixed to the pin points 28 whereas the front of the scissor lift slides backward through the constrained channels 24. Through this operation, the work platform 20 is raised upward directly over its raised position. There is no lateral movement in the work platform 20 as it is raised. A person having ordinary skill in the art will realize that the scissor lift 10 can be reversed such that the pin points 28 are toward the front of the base and work platforms 18, 20 and the sliders 22 with constrained channels 24 are toward the back of the respective platforms. Even with this configuration, the work platform 20 would be lifted upward directly above its resting position with no lateral movement.

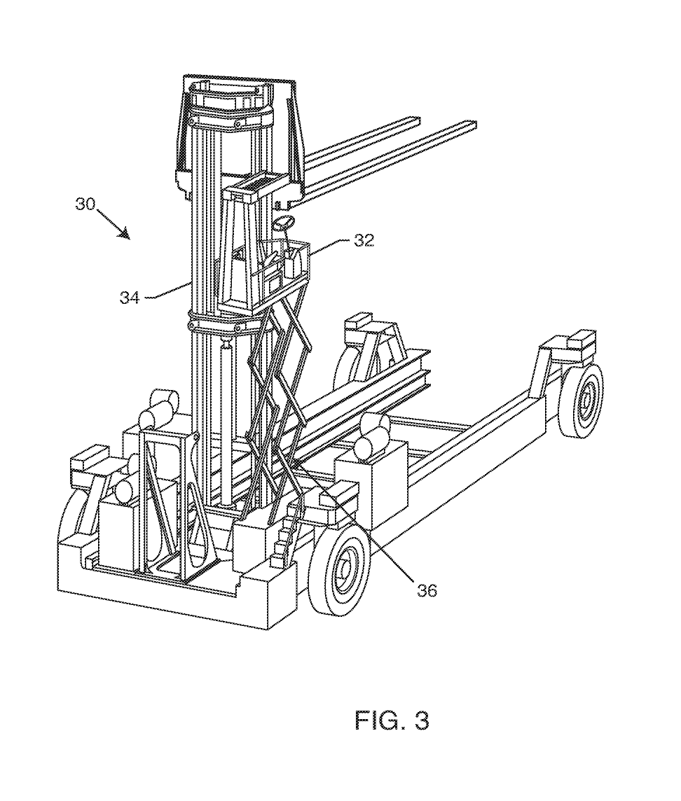

In the boat lifting and stacking vehicle 30 of FIG. 3, it would be desirable in certain instances to have the vehicle operator console 32 positioned further back on the vehicle 30 when in a raised position so as not to come into contact with the forklift mast 34. This is particularly important where the forklift mast may be tilted or angled in a direction that brings it in closer proximity to the operator console 32, i.e., backwards. It is not desirable to simply move the operator console 32 farther back on the vehicle 30 as this may result in a longer vehicle 30, thus making the same less maneuverable in confined spaces.

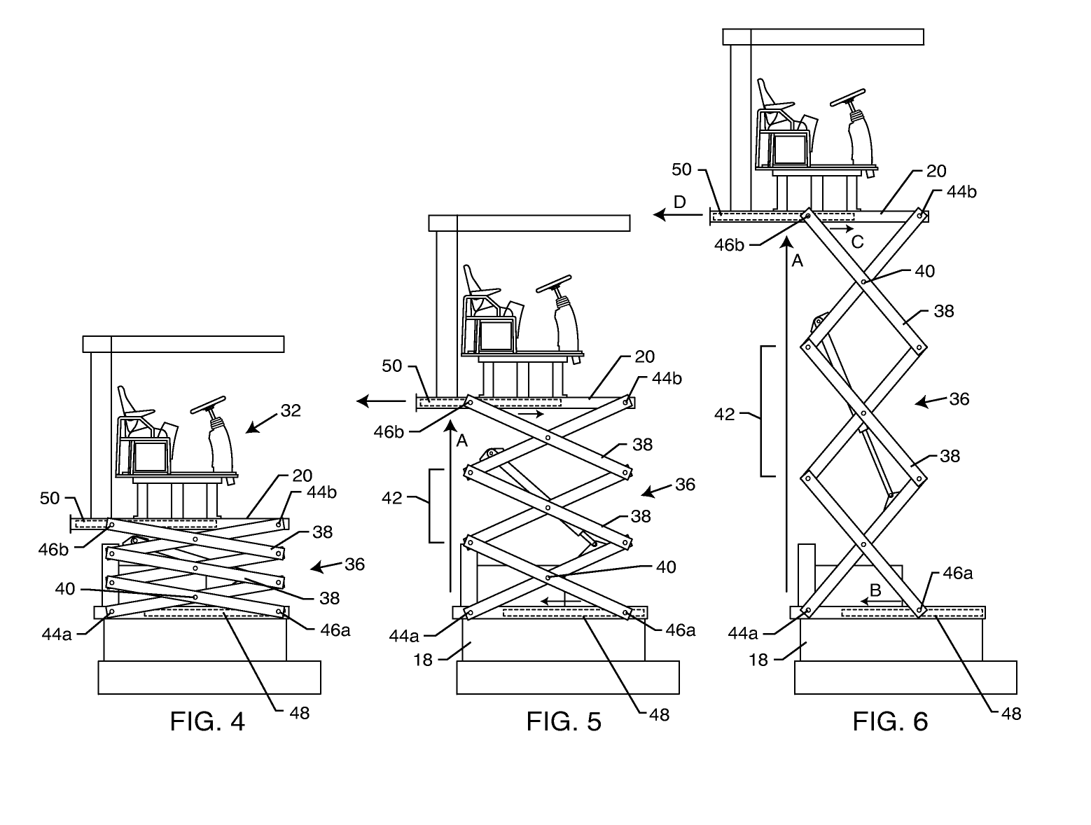

Accordingly, the present invention as detailed in FIGS. 4-6 has been developed. The inventive slider scissor lift 36 has a construction of bars 38, pins 40 and X-shaped structures 42 as described in the prior art embodiment. The inventive slider scissor lift 36 differs from the prior art embodiment 10 in how it is connected to the base platform 18 and work platform 20. In the inventive slider scissor lift 36, the pin points 44 are positioned oppositely as between the base platform 18 and work platform 20. Similarly, the sliders 46 are oppositely positioned.

More specifically, the lower pin point 44a is fixed adjacent to the rear of the base platform 18 and the upper pin point 44b is fixed adjacent to the front of the work platform 20. The lower slider 46a is positioned in a lower constrained channel 48 near the front of the base platform 18 and the upper slider 46b is positioned in an upper constrained channel 50 near the rear of the work platform 20. In this configuration as the scissor lift 36 raises (Arrow A) the operator console 32 from a lowered position (FIG. 4) through an intermediate position (FIG. 5) to a fully raised position (FIG. 6) the work platform 20 and the operator console 32 resting thereon move laterally backwards (Arrow D). This lateral movement is due to the opposite placement of the lower pin point 44a and upper pin point 44b. One will realize that if the positions of the lower pin point 44a and lower slider 46a are reversed as well as the positions of the upper pin point 44b and upper slider 46b, the work platform 20 will experience forward movement as it is raised by the scissor lift 36.

As illustrated in the series of FIGS. 4-6, the lower slider 46a and upper slider 46b move through the respective lower constrained channel 48 (Arrow B) and upper constrained channel 50 (Arrow C) as the scissor lift 36 is raised. This sliding movement brings the sliders 46 closer to the pin points 44. Because the pin points 44 and sliders 46 are oppositely positioned as they are brought closer to one another, the platform is moved in the same direction as the lower slider 46a (Arrow B) on the base platform 18.

By reversing the locations of the pin points 44 and sliders 46 on the work platform 20 as compared to the prior art, the work platform 20 then moves backward as the scissor lift 36 rises. In the preferred embodiment with the scissor lift 36 fully raised, the front most portion of the work platform 20 and operator console 32 moves back about half the length of the work platform 20. For example, if the work platform were eight feet long, the platform and operator console would move back a distance of four feet. Such movement is sufficient to provide clearance from a forklift mast 44 that is tilted back several degrees. Any potential instability from a work platform 20 moving backward is resolved by the fixing of the base platform 18 to the chassis of the vehicle 30 which has a broad footprint for greater stability.

Although several embodiments have been described in detail for purposes of illustration, various modifications may be made without departing from the scope and spirit of the invention. Accordingly, the invention is not to be limited, except as by the appended claims.

What is claimed is:

1. A slider scissor lift for a vehicle operator console, comprising:
a work platform carrying the operator console;
a base platform associated with the vehicle; and
a scissor lift disposed between the work platform and the base platform, the scissor lift including a lower fixed pin connected to the base platform adjacent to a first end of the vehicle, and an upper fixed pin connected to the work platform adjacent to an opposite second end of the vehicle.

2. The slider scissor lift of claim 1, further comprising upper and lower sliders on the scissor lift positioned oppositely from the upper and lower fixed pins, wherein the lower slider moves along a lower constrained channel on the base platform adjacent to the second end, and wherein the upper slider moves along an upper constrained channel on the work platform adjacent to the first end.

3. The slider scissor lift of claim 1, wherein the first end is a rear end of the vehicle and the second end is a front end of the vehicle.

4. The slider scissor lift of claim 1, wherein the first end is a front end of the vehicle and the second end is a rear end of the vehicle.

5. The slider scissor lift of claim 1, further comprising a pair of scissor lifts disposed between the base platform and the work platform, each scissor lift including lower fixed pins connected to the base platform adjacent to the first end, and upper fixed pins connected to the work platform adjacent to the second end.

6. The slider scissor lift of claim 5, further comprising upper and lower sliders on each of the scissor lifts positioned oppositely from the upper and lower fixed pins, wherein the lower sliders each move along lower constrained channels on the base platform adjacent to the second end and the upper sliders each move along upper constrained channels on the work platform adjacent to the first end.

7. The slider scissor lift of claim 1, further comprising a hydraulic cylinder for opening and closing the scissor lift.

8. A slider scissor lift for a vehicle operator console, comprising:
a work platform carrying the operator console;
a base platform associated with the vehicle;
a scissor lift disposed between the work platform and the base platform, the scissor lift including a lower fixed pin connected to the base platform adjacent to a first end of the vehicle, and an upper fixed pin connected to the work platform adjacent to an opposite second end of the vehicle;
upper and lower sliders on the scissor lift positioned oppositely from the upper and lower fixed pins, wherein the lower slider moves along a lower constrained channel on the base platform adjacent to the second end, and wherein the upper slider moves along an upper constrained channel on the work platform adjacent to the first end; and
a hydraulic cylinder for opening and closing the scissor lift.

9. The slider scissor lift of claim 8, wherein the first end is a rear end of the vehicle and the second end is a front end of the vehicle.

10. The slider scissor lift of claim 8, wherein the first end is a front end of the vehicle and the second end is a rear end of the vehicle.

11. The slider scissor lift of claim 8, further comprising a pair of scissor lifts disposed between the base platform and the work platform, each scissor lift including lower fixed pins connected to the base platform adjacent to the first end, and upper fixed pins connected to the work platform adjacent to the second end.

12. The slider scissor lift of claim 11, further comprising upper and lower sliders on each of the scissor lifts positioned oppositely from the upper and lower fixed pins, wherein the lower sliders each move along lower constrained channels on the base platform adjacent to the second end and the upper sliders each move along upper constrained channels on the work platform adjacent to the first end.

13. A slider scissor lift for a vehicle operator console, comprising:
a work platform carrying the operator console;
a base platform associated with the vehicle;
a pair of scissor lifts disposed between the base platform and the work platform, each scissor lift including lower fixed pins connected to the base platform adjacent to a first end of the vehicle, and upper fixed pins connected to the work platform adjacent to an opposite second end of the vehicle; and
a hydraulic cylinder for opening and closing the scissor lift.

14. The slider scissor lift of claim 13, wherein the first end is a rear end of the vehicle and the second end is a front end of the vehicle.

15. The slider scissor lift of claim 13, wherein the first end is a front end of the vehicle and the second end is a rear end of the vehicle.

16. The slider scissor lift of claim 13, further comprising upper and lower sliders on each of the scissor lifts positioned oppositely from the upper and lower fixed pins, wherein the lower sliders each move along lower constrained channels on the base platform adjacent to the second end and the upper sliders each move along upper constrained channels on the work platform adjacent to the first end.
